(19) United States
(12) Patent Application Publication
(10) Pub. No.: US 2018/0011542 A1
(43) Pub. Date: Jan. 11, 2018

(54) USER INTERFACE DEVICE, VEHICLE INCLUDING THE SAME, AND METHOD OF CONTROLLING THE VEHICLE

(71) Applicant: HYUNDAI MOTOR COMPANY, Seoul (KR)

(72) Inventors: Jongmin OH, Suwon-si (KR); Seunghyun WOO, Seoul (KR); Daeyun AN, Anyang-si (KR)

(21) Appl. No.: 15/374,659

(22) Filed: Dec. 9, 2016

(30) Foreign Application Priority Data
Jul. 11, 2016 (KR) 10-2016-0087676

(51) Int. Cl. G06F 3/01; B60H 1/00; B60R 1/00; B60H 1/34; B60K 37/02

(52) U.S. Cl. CPC G06F 3/017; B60H 1/34; B60K 37/02; B60R 1/00; B60H 1/00742; B60K 2350/104; B60K 2350/102; B60K 2350/1012; B60K 2350/2013; B60K 2350/352; B60R 2300/207; B60Y 2400/92; B60K 2350/1052

(57) ABSTRACT

A user interface device includes: an output device having an output region predefined around an output unit; an acquisition unit acquiring information about a user's gesture performed around the output region; and a controller determining an area of a shielded region which is shielded by the user's gesture in the output region based on the acquired information and controlling output of the output device.

### CROSS-REFERENCE TO RELATED APPLICATION(S)

This application claims the benefit of priority to Korean Patent Application No. 10-2016-0087676, filed on Jul. 11, 2016 in the Korean Intellectual Property Office, the disclosure of which is incorporated herein by reference.

### TECHNICAL FIELD

The present disclosure relates to a user interface device capable of controlling an output of an output device by shielding an output region, a vehicle including the same, and a method of controlling the vehicle.

### BACKGROUND

Vehicles provide basic driving functions by controlling speed, engine revolutions per minute (RPM), fuel level, cooling water, and the like, and also provide audio video and navigation (AVN) functions, and functions of controlling an air conditioner, seats, and lighting in addition to the basic driving functions.

Such vehicles may further include a user interface device to input control commands regarding various functions and output operation states of the functions. The user interface device is a physical medium for communication between a user and various constituent elements of the vehicle to be controlled. Recently, research into user interface devices to improve the convenience of users to control vehicles has been conducted.

### SUMMARY

An aspect of the present disclosure provides a user interface device to control output of an output device depending on the degree of shielding an output region of the output device, a vehicle including the same, and a method of controlling the vehicle.

Additional aspects of the disclosure will be set forth in part in the description which follows and, in part, will be obvious from the description, or may be learned by practice of the disclosure.

In accordance with an exemplary embodiment of the present disclosure, a user interface device includes: an output device having an output region predefined around an output unit; an acquisition unit acquiring information about a user's gesture performed around the output region; and a controller determining an area of a shielded region that is shielded by the gesture in the output region based on the acquired information and controlling an output of the output device.

The user's gesture may comprise a gesture of shielding the output region with a user's hand.

The output region may be defined in the same shape as that of the output device.

The controller may determine a ratio of a shielded region to the output region and controls the output of the output device based on the determined ratio.

The controller may control the output of the output device to decrease as the ratio of the shielded region to the output region increases.

The controller may determine a movement direction of the gesture based on the acquired information about the gesture, and control an output direction of the output device based on information about the movement direction of the gesture.

Upon determination that a size of the user's hand is less than that of the output region based on the acquired information, the controller may determine a ratio of a region of the hand shielding the output region to the entire region of the hand and controls the output of the output device based on the determined ratio.

The output device may comprise a display device, and a size of a screen of the display device is controlled based on a predetermined point of the user's hand.

The controller may control operation of activating a function of the user interface device if the user's gesture of shielding the output region stops around the output region for a reference period.

The output device may comprise at least one of a speaker, an AVN device, an air conditioner, and a window as the output device installed in the vehicle to be controlled.

The acquisition unit may comprise at least one of an image acquisition unit, a distance sensor, and a proximity sensor to acquire information about the user's gesture.

The acquisition unit may be installed around the output device to acquire information about the user's gesture performed around the output device.

In accordance with another exemplary embodiment of the present disclosure, a vehicle includes: an output device having an output region predefined around an output unit; an acquisition unit acquiring information about a user's gesture performed around the output region; and a controller determining an area of a shielded region shielded by the gesture in the output region based on the acquired information and controlling an output of the output device.

The user's gesture may comprise a gesture of shielding the output region with a user's hand.

The output region may be defined in the same shape as that the output device.

The controller may determine a ratio of a shielded region to the output region and controls the output of the output device based on the determined ratio.

The controller may control the output of the output device to decrease as the ratio of the shielded region to the output region increases.

The controller may determine a movement direction of the gesture based on the acquired information about the gesture, and controls an output direction of the output device based on information about the movement direction of the gesture.

Upon determination that a size of the user's hand is less than that of the output region based on the acquired information, the controller may determine a ratio of a region of the hand shielding the output region to the entire region of the hand and controls the output of the output device based on the determined ratio.

The output device further comprises a display device, and a size of a screen of the display device is controlled based on a predetermined point of the user's hand.

The controller may control operation of activating a function of the user interface device if the user's gesture shielding the output region stops around the output region for a reference period.

In accordance with another exemplary embodiment of the present disclosure, a method of controlling a vehicle, which includes an output device having an output region predefined around an output unit, and an acquisition unit acquiring information about a user's gesture performed around the output region, includes: acquiring the information about the user's gesture; determining an area of a shielded region shielded by the gesture in the output region of the output device based on the acquired information; and controlling an output of the output device based on information about the determined area.

The controlling of the output of the output device based on the information about the determined area may comprise determining a ratio of the shielded region to the output region and controlling the output of the output device based on the determined ratio.

The controlling of the output of the output device based on the information about the determined area may comprise controlling an output intensity of the output device to decrease as the ratio of the shielded region to the output region increases.

The method may further comprise determining a size of the user's hand based on the information acquired by the acquisition unit, and the controlling of the output of the output device comprises determining a ratio of a region of the hand shielding the output region to the entire region of the hand if the determined size of the user's hand is less than that of the output region of the output device, and controlling the output of the output device based on the determined ratio.

The method may further comprise determining a period during which the gesture stops around the output region based on the acquired information about the user's gesture, and converting the operation of activating the function of the user interface device when the gesture stops around the output region for a reference period.

The method may further comprise determining a movement direction of the gesture based on the acquired information about the user's gesture, and converting an output direction of the output device based on information about the movement direction of the gesture.

### BRIEF DESCRIPTION OF THE DRAWINGS

These and/or other aspects of the disclosure will become apparent and more readily appreciated from the following description of the embodiments, taken in conjunction with the accompanying drawings.

FIG. 1 is an exterior view of a vehicle according to an embodiment of the present disclosure.

FIG. 2 is an interior view of the vehicle according to an embodiment of the present disclosure.

FIG. 3 is a control block diagram of a user interface device according to an embodiment of the present disclosure.

FIG. 4 illustrates a sensing area of an image acquisition unit according to an embodiment of the present disclosure, more particularly, a sensing area of a camera if the camera is used as the image acquisition unit.

FIG. 5 is a diagram illustrating installation positions of a distance sensor and a proximity sensor according to an embodiment of the present disclosure.

FIG. 6 is a diagram for describing a method of determining a ratio of a shielded region to output region A of an output device.

FIG. 7 is a diagram for describing a process of controlling an output of an air conditioner air vent as an output device.

FIG. 8 is a diagram for describing a process of controlling a speaker as an output device.

FIG. 9 is a diagram for describing a method of controlling an output direction of an output device in accordance with a movement direction of a gesture.

FIG. 10 is a diagram for describing a method of controlling an output of an output device after determining a ratio of a portion of a user's hand shielding output region A to the entire area of a user's hand.

FIGS. 11A to 11C are diagrams for describing methods of controlling a size of a screen of an output device based on one point of a gesture.

FIG. 12 is a flowchart for describing a process of controlling a vehicle according to an embodiment of the present disclosure.

FIG. 13 is a flowchart for describing a process of controlling a vehicle according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

Hereinafter, a user interface device, a vehicle including the same, and a method of controlling the vehicle according to embodiments of the present disclosure will be described in detail.

User interface devices are physical media for communication between humans and objects. A user interface device according to an embodiment may be applied to vehicles and various other apparatuses including display devices. Hereinafter, a user interface device installed in a vehicle will be exemplarily described for descriptive convenience. However, the user interface device is not limited thereto.

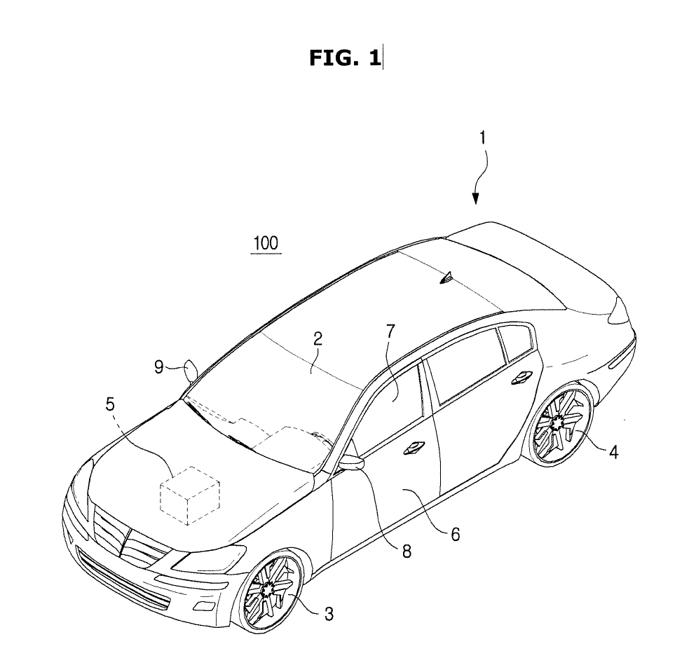

FIG. 1 is an exterior view of a vehicle according to an embodiment of the present disclosure.

Referring to FIG. 1, a vehicle 100 may include a main body 1 defining an appearance of the vehicle 100, a front glass 2 providing a driver sitting in the vehicle 100 with views in front of the vehicle 100, wheels 3 and 4 moving the vehicle 100, a driving device 5 rotating the wheels 3 and 4, doors 6 shielding the inside of the vehicle 100 from the outside, and side mirrors 7 and 8 providing the driver with views behind the vehicle 100.

The front glass 2 is disposed at a front upper portion of the main body 1 to allow the driver sitting in the vehicle 100 to acquire information about views in front of the vehicle 100 and is also called a windshield glass.

The wheels 3 and 4 include front wheels 3 disposed at front portions of the vehicle 100 and rear wheels 4 disposed at rear portions of the vehicle 100. The driving device 5 may provide the front wheels 3 or the rear wheels 4 with a rotational force such that the main body 1 moves forward or backward. The driving device 5 may include an engine generating the rotational force by combustion of fossil fuels or a motor generating the rotational force by receiving power from an electric condenser (not shown).

The doors 6 are pivotally coupled to the main body 1 at left and right sides of the main body 1 and the driver may get into the vehicle 100 by opening the door, and the inside of the vehicle 100 may be shielded from the outside by closing the door. The doors 6 may have windows 7 through which the inside of the vehicle 100 is visible and vice versa. According to an embodiment, the windows 7 may be tinted to be visible from only one side and may be opened and closed.

The side mirrors 8 and 9 include a left side mirror 8 disposed at the left side of the main body 1 and a right side mirror 9 disposed at the right side of the main body 1 and allow the driver sitting in the vehicle 100 to acquire information about sides and the rear of the vehicle 100.

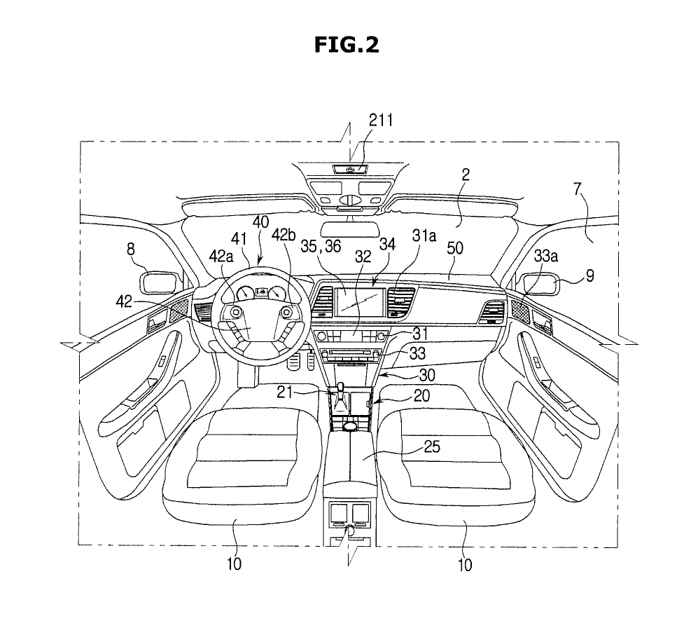

FIG. 2 is an interior view of the vehicle 100 according to an embodiment of the present disclosure.

Referring to FIG. 2, the vehicle 100 may include seats 10 on which a driver and passengers sit, a center console 20, and a dashboard 50 provided with a center fascia 30, a steering wheel 40, and the like.

The center console 20 may be disposed between a driver's seat and a front passenger's seat to separate the driver's seat from the front passenger's seat. The center console 20 may be provided with a gear box in which a gear device is installed. A transmission lever 21 to change gears of the vehicle 100 may be installed in the gear box.

An arm rest 25 may be disposed behind the center console 20 to allow the passengers of the vehicle 100 to rest arms. The arm rest 25 may be ergonomically designed for the convenience of the passengers such that the passengers comfortably rest arms.

The center fascia 30 may be provided with an air conditioner 21, a clock 32, an audio device 33, and an audio, video, and navigation (AVN) device 34.

The air conditioner 31 maintains the inside of the vehicle 100 in a clean state by controlling temperature, humidity, and cleanness of air, and an air flow inside the vehicle 100. The air conditioner 31 may include at least one air conditioner air vent 31a installed at the center fascia 30 though which air is discharged.

The air conditioner 31 may be controlled by manipulating a button or dial disposed at the center fascia 30 or by shielding a portion of an output region of the air conditioner air vent 31a according to an embodiment.

Hereinafter, the output region is defined as a predefined region around an output unit of the output device. Here, the region around the output unit of the output device may be a region including the output unit of the output device. In this case, the output region may include the output unit. The region around the output unit of the output device may be a region spaced apart from the output unit of the output device at a predetermined distance. The output region may not include the output unit.

According to an embodiment of the present disclosure, the output region may be defined as a region having a shape of the output unit of the output device. More particularly, the output region of the air conditioner 31 may be defined as a region around the air conditioner air vent 31a in a shape similar to that of the air conditioner air vent 31a. However, the method of defining the output region is not limited thereto and will be described later in more detail.

The clock 32 may be disposed near the bottom or dial to control the air conditioner 31.

The audio device 33 may be installed at the center fascia 30 and provide a radio mode to provide radio functions and a media mode to reproduce audio files of various storage media storing the audio files. The audio device 33 may include at least one speaker 33a to output sounds.

The audio device 33 may be controlled by manipulating a button or dial provided at the center fascia 30 or by shielding a portion of an output region of the speaker 33a installed in the vehicle 100 according to an embodiment. This will be described in more detail later.

The AVN device 34 may be embedded in the center fascia 30 of the vehicle 100. The AVN device 34 is a device performing the overall operation of audio functions, video functions, and navigation functions in accordance with manipulation of a user.

The AVN device 34 may include an input unit 35 to receive a command from the user regarding the AVN device 34 and a display 36 to display screens related to the audio functions, video functions, or navigation functions. Although FIG. 2 illustrates that the input unit 35 is integrated with the display 36, the input unit 35 is not limited thereto.

The AVN device 34 may be controlled by touching the input unit 35 or by shielding a portion of the display 36 according to an embodiment. This will be described in more detail later.

The steering wheel 40 controls a direction of the vehicle 100 and includes a rim 41 gripped by the driver and a spoke 42 connected to a steering apparatus of the vehicle 100 and connecting the rim 41 with a hub of a rotating shaft for steering. According to an embodiment, the spoke 42 may include manipulators 42a and 42b to control various devices of the vehicle 100, for example, the audio device 33.

The dashboard 50 may have an instrument cluster to display driving speed of the vehicle 100, an engine RPM, a fuel level, or the like and a glove box for miscellaneous storage.

The user interface device may be installed in the vehicle 100. A user may efficiently control various functions equipped in the vehicle 100 by using the user interface device installed in the vehicle 100. For example, the user may control the output of the output device by a gesture of shielding the output region defined around the output device of the user interface device. The user interface device may be a concept including the output device. The output device may be connected to a controller of the user interface device according to an embodiment.

Hereinafter, the user interface device according to an embodiment will be described in more detail. Embodiments will be described based on the user interface device for descriptive convenience. Descriptions of the vehicle 100 which are the same as those of the user interface device to be described later will not be given.

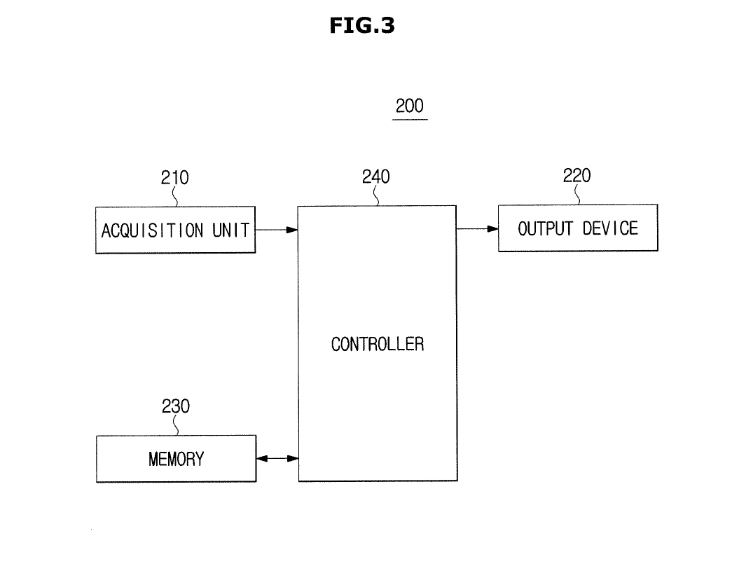

FIG. 3 is a control block diagram of a user interface device 200 according to an embodiment.

Referring to FIG. 3, the user interface device 200 according to an embodiment may include an acquisition unit 210, an output device 220, a memory 230, and a controller 240.

The acquisition unit 210 may acquire information about a user's gesture performed around the output device 220. In this case, the user's gesture is defined as a motion with a user's hand to control the output of the output device 220 around the output unit of the output device 220. For example, the user's gesture may include a motion shielding the entire output region of the output device 220 or a portion thereof. In a broad sense, the user's gesture may include a stop motion in a given region and a moving motion in a preset direction.

The acquisition unit 210 may be implemented in various manners. The acquisition unit 210 may include an image acquisition unit configured to acquire image information about the gesture performed around the output region of the output device 220 and may also include a distance sensor, a proximity sensor, or the like. In other words, the acquisition unit 210 may be implemented using at least one of the image acquisition unit, the distance sensor, the proximity sensor, or any combination thereof.

The image acquisition unit may include a camera installed at a ceiling of the inside of the vehicle 100. The image acquisition unit may acquire information about the user's gesture performed around the output region of the output device 220 and transmit the acquired information to the controller 240. The controller 240 may include an electronic control unit (ECU).

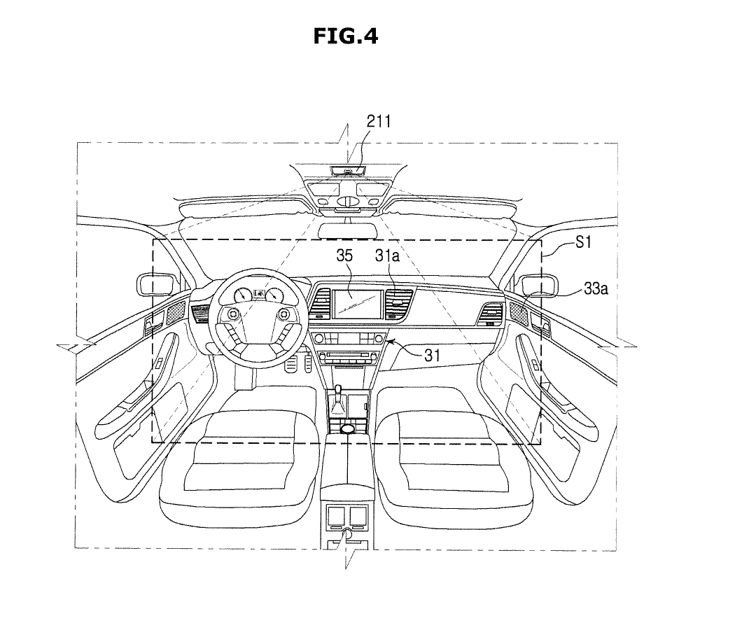

To this ends, the image acquisition unit may have a sensing area defined to acquire information about the output device 220 installed in the vehicle 100. FIG. 4 illustrates the sensing area of the image acquisition unit according to an embodiment, more particularly, a sensing area of a camera if the camera is used as the image acquisition unit.

Referring to FIG. 4, an image acquisition unit 211 according to an embodiment may be arranged such that a sensing area S1 includes the center fascia 30 of the vehicle 100. Since devices of the vehicle 100 to be controlled are installed in the center fascia 30, the sensing area S1 may include output units of the devices of the vehicle 100, i.e., output units of the output devices 220.

For example, the sensing area S1 may include at least one of the speaker 33a, the display 35, the air conditioner 31, and the windows 7. Defining of the sensing area S1 of the image acquisition unit 211 (size, shape, and the like) is not limited thereto, and the sensing area S1 may be defined in various manners by setting of the user.

If a user's hand approaches the output device 220, the distance sensor acquires information about a distance from the output device 220 to the user's hand and transmits the information to the controller 240. The distance sensor may be implemented using at least one of an infrared sensor and an ultrasound sensor, without being limited thereto.

If the user's hand approaches a region around the output device 220, the proximity sensor may acquire information about a position of the user's hand and transmit the information to the controller 240. The proximity sensor may be implemented using a sensor fabricated by combining a hole device and a permanent magnet, a sensor fabricated by combining a light emitting diode and an optical sensor, or a capacitive displacement measurement device, without being limited thereto.

The information about distance or position acquired by the distance sensor or the proximity sensor may be transmitted to the controller 240 and used to control operation of activating the user interface device 200.

The distance sensor and the proximity sensor may be respectively installed around the output device 220 and acquire information about an approach of the user to a region around the output device 220.

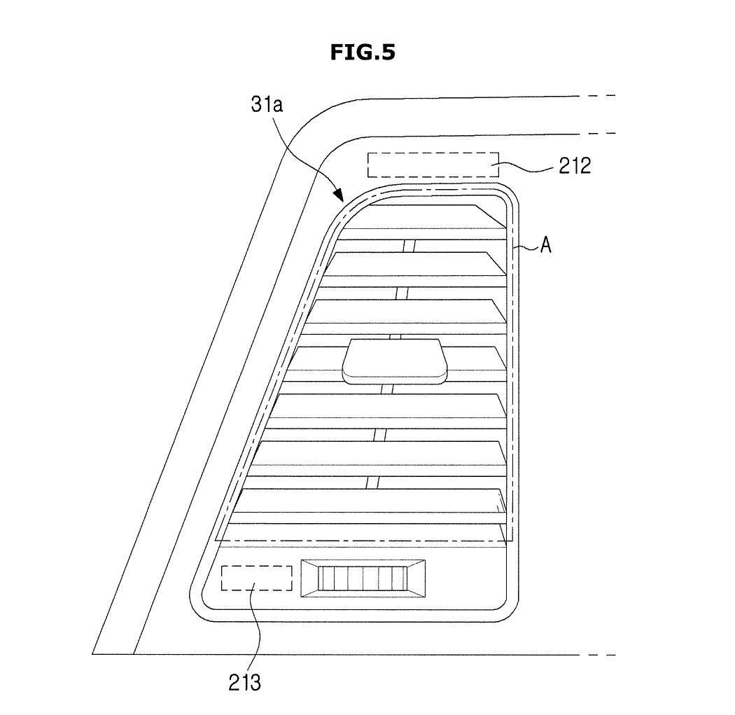

FIG. 5 is a diagram illustrating installation positions of a distance sensor and a proximity sensor according to an embodiment of the present disclosure.

Referring to FIG. 5, a distance sensor 212 and a proximity sensor 213 may be installed around the output unit of the output device 220, for example, around the air conditioner air vent 31a of the air conditioner 31. Although the air conditioner air vent 31a of the air conditioner 31 is exemplarily illustrated in FIG. 5, the output device 220 is not limited to that illustrated in FIG. 5 and may include various devices to be controlled equipped in the vehicle 100.

An output region A may be preset around the output unit of the output device 220. The output region A may vary in accordance with types of the output device 220. Even when the types of the output device 220 are the same, the output region A may vary in accordance with the shape of the output unit of the output device 220. The size, shape, and the like of the output region A may vary according to the user or designer.

The output device 220 may include at least one of the speaker 33a, the display 35, the air conditioner 31, and the windows 7. However, the types of the output device 220 are not limited thereto and the output device 220 may include various other output devices installed in the vehicle 100 well known in the art.

The memory 230 may store a variety of data, programs, or applications to control various functions provided in the user interface device 200 or the vehicle 100 under the control of the controller 240. More particularly, the memory 230 may store control programs to control the user interface device 200 or the output device 220 of the vehicle 100, specialized applications initially provided by a manufacturer or general-purpose applications downloaded from the outside, objects to provide applications (e.g., image, text, icon, and button), user information, documents, databases, or related data.

The memory 230 may temporarily store acquired signals received from the acquisition unit 210 of the user interface device 200 or data required to allow the controller 240 to recognize a user's gesture by using the acquired signals. For example, the memory 230 may store image information of the sensing area S1 of the image acquisition unit 211 and may also store mapping information of the output unit of the output devices 220 included in the image information.

The memory 230 may include at least one storage medium of a flash memory, a hard disc, a memory card, a read-only memory (ROM), a random access memory (RAM), an electrically erasable programmable read-only memory (EEPROM), a programmable read-only memory (PROM), a magnetic memory, a magnetic disc, and an optical disc.

The controller 240 controls the overall operation of the user interface device 200 or the vehicle 100 and a flow of signals between constituent elements thereof and processes data. The controller 240 may execute an operation system (OS) and various applications stored in the memory 230 upon receiving a user's input or if preset conditions are satisfied.

The controller 240 may include a ROM to store at least one processor and a control program to control the user interface device 200 and a RAM to store information acquired by the acquisition unit 210 of the user interface device 200 or to be used as a storage corresponding to various operations performed by the user interface device 200. Hereinafter, the ROM and the RAM of the controller 240 may be separated from the memory 230 or integrated into the memory 230,

Upon determination that a user's gesture stops in the output region A of the output device 220 for a preset first period, the controller 240 may control operation of activating the user interface device 200 based on gesture information acquired by the acquisition unit 210.

For example, upon determination that the user's gesture stops around the output region A of the output device 220 for the preset first period when the user interface device 200 is inactivated, the controller 240 may convert the user interface device 200 into an active state. On the contrary, upon determination that the user's gesture stops around the output region A of the output device 220 for the preset first period when the user interface device 200 is activated, the controller 240 may convert the user interface device 200 into an inactive state. In this case, the first period may be set by the user. For example, the first period may be set to 2 to 3 seconds and may vary in accordance with settings by the user.

If the user interface device 200 is converted from the inactive state into an On state, the controller 240 may output an alarm to the user. For example, the controller 240 may notify the user of the state of the user interface device 200 by using sounds, colors, light, or a graphical user interface (GUI).

Upon determination that the user's gesture stops around the output region A for less than the preset first period, the controller 240 determines the user's gesture as an insignificant gesture and does not perform controlling of the user interface device 200.

Although a time variable is described above as a variable used for the operation of activating the user interface device 200, any other variables such as a gesture variable may also be used in addition to the time variable.

The controller 240 may control the output of the output device 220, based on information about the user's gesture acquired by the acquisition unit 210. More particularly, the controller 240 may determine an area of a shielded region shielded by the user's gesture in the output region A of the output device 220 based on the information about the user's gesture acquired by the acquisition unit 210 and control the output of the output device 220 based on the information about the determined area.

The controller 240 may control the output of the output device 220 by further considering a variable about shielding time together with the area shielded by the gesture. For example, upon determination that the user's gesture stops around the output region A for a preset second period, the controller 240 may control the output of the output device 220. In this case, the second time may be set to several seconds by the user, without being limited thereto. Hereinafter, the method of controlling the output device 220 will be described based on the shielded area for descriptive convenience. However, shielding time may also be applied to the method of controlling the output of the output device 220 as a variable in addition to the area of the shielded region.

As described above, the acquisition unit 210 may include at least one of the image acquisition unit 211, the distance sensor 212, and the proximity sensor 213. The controller 240 may control the output of the output device 220, based on information about the user's gesture acquired by the acquisition unit 210. Hereinafter, the embodiment will be described based on the image acquisition unit 211 for descriptive convenience. However, the output of the output device 220 may also be controlled based on information acquired by the distance sensor 212 and the proximity sensor 213 within a range obvious to one or ordinary skill in the art.

If a user's gesture of shielding the output region A of the user interface device 200 is input, the image acquisition unit 211 may output acquired image information to the controller 240. The controller 240 may determine a size of a user's hand based on the image information received from the image acquisition unit 211 and compare the determined size of the user's hand with a size of the output region A. More particularly, the controller 240 may compare the size of the user's hand with the size of the output region A of the output device 220 to be controlled based on image information about the sensing area S1 of the image acquisition unit 211 prestored in the memory 230 and mapping data of the output unit of the output device 220 regarding the image information.

If the size of the user's hand is greater than the size of the output region A of the output device 220, the controller 240 may determine a ratio of the shielded region shielded by the gesture to the output region A of the output device 220 and control the output of the output device 220 based on the determined ratio.

When determining the ratio of the shielded region shielded by the gesture to the output region A of the output device 220, the controller 240 may determine a ratio of a region directly shielded by the hand to the output region A of the output device 220 as the ratio of the shielded region shielded by the gesture.

The controller 240 may also determine a ratio of a region shielded by the hand to the output region A of the output device 220 based on a predetermined point of the hand as the ratio of the shielded region shielded by the gesture. In this case, the predetermined point of the hand may be at least one of upper and lower ends of the hand of the user shielding the output region A of the output device 220.

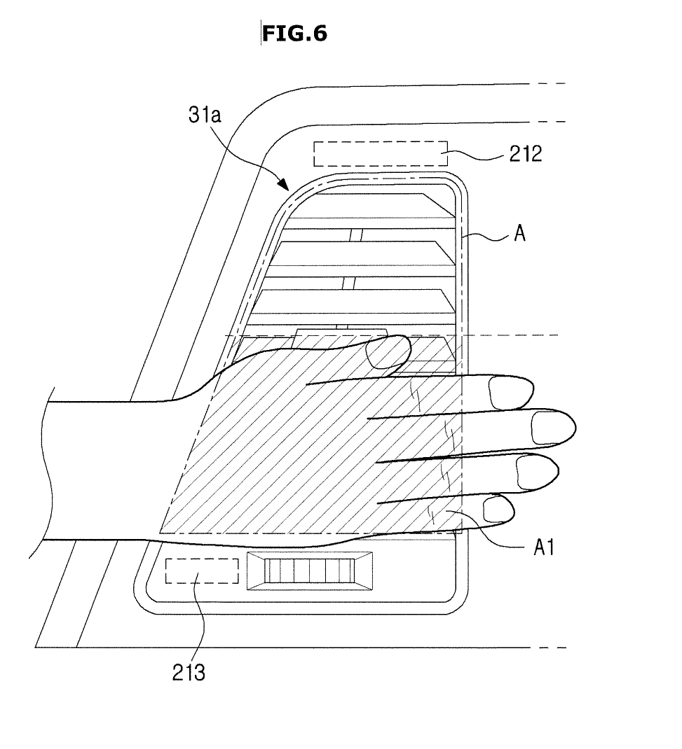

FIG. 6 is a diagram for describing a method of determining a ratio of the shielded region to the output region A of the output device 220. Although FIG. 6 illustrates the air conditioner air vent 31a as the output device 220, the same principles may also be applied to any other output devices 220.

Referring to FIG. 6, first, the user may perform a gesture of shielding a portion of the output region A of the output device 220. Upon recognition of the user's gesture, the controller 240 may determine a shielded region A1 shielded by the user's hand in the output region based on the upper end of the hand shielding the output region A of the output device 220. Upon determination of the shielded region A1 shielded by the user's hand in the output region, the controller 240 may determine a ratio R1 of the shielded region A1 shielded by the user's hand to the output region A of the output device 220 and control the output of the output device 220 based on the determined ratio R1. According to an embodiment, the controller 240 may also determine a ratio of a region not shielded by the user's hand to the output region A and control the output of the output device 220 based on the determined ratio.

Upon determination of the ratio R1 of the shielded region shielded by the user's hand to the output region A, the controller 240 may control the output of the output device 220 based on the determined ratio R1. Particularly, as the ratio R1 of the shielded region A1 shielded by the user's hand to the output region A of the output device 220 increases, the controller 240 may control the output device 220 to decrease an output intensity. On the contrary, the controller 240 may also control the output device 220 to increase the output intensity.

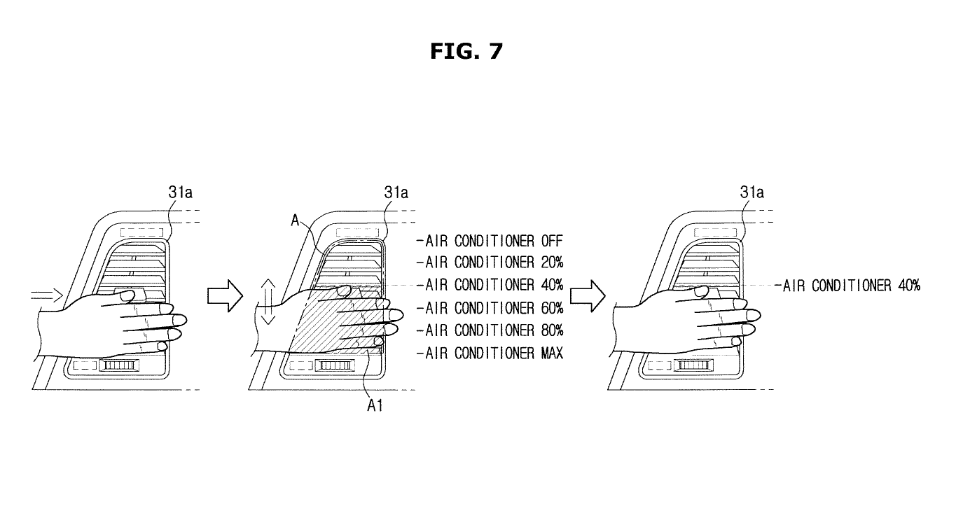

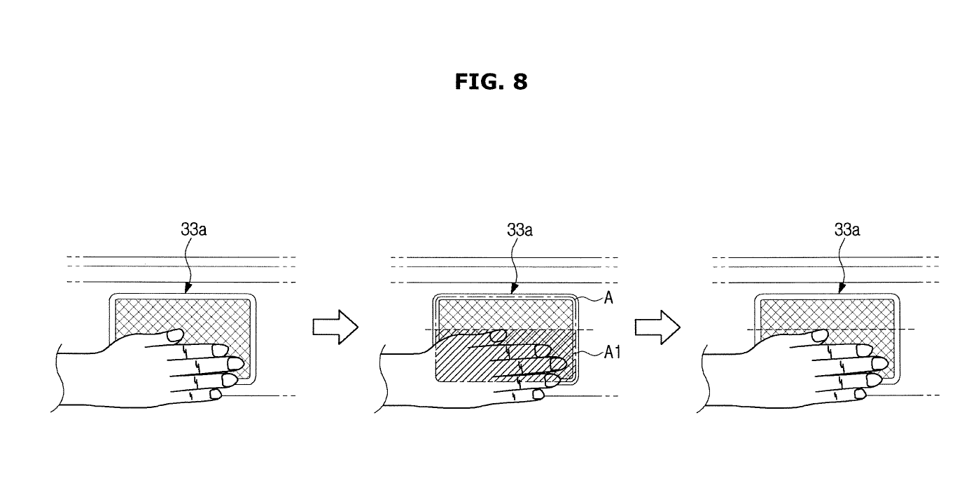

Hereinafter, a method of controlling the controller 240 will be described in detail regarding the accompanying drawings. FIG. 7 is a diagram for describing a process of controlling the output of the air conditioner air vent 31a as the output device 220. FIG. 8 is a diagram for describing a process of controlling the speaker 33a as the output device 220.

First, referring to FIG. 7, upon determination that the user's gesture stops in the output region A of the air conditioner air vent 31a for the preset first period based on gesture information acquired by the acquisition unit 210, the controller 240 may convert the function of the output device 220 into an active state.

If the user interface device 200 is activated, a process of controlling the output of the air conditioner air vent 31a is performed. When the ratio R1 of the shielded region A1 shielded by the user's hand to the output region A of the air conditioner air vent 31a increases, the controller 240 may control the output intensity of the air conditioner air vent 31a to decrease. For example, the controller 240 may control the output intensity of the air conditioner air vent 31a such that a strength of wind output from the air conditioner air vent 31a gradually decreases, or the controller 240 may control the output intensity of the air conditioner air vent 31a such that a temperature of wind output from the air conditioner air vent 31a gradually decreases.

Next, referring to FIG. 8, upon determination that the user's gesture stops in the output region A of the speaker 33a for the preset first period based on gesture information acquired by the acquisition unit 210, the controller 240 may convert the function of the user interface device 200 into an active state.

If the user interface device 200 is activated, a process of controlling the output of the speaker 33a may be performed. When the ratio R1 of the shielded region A1 shielded by the user's hand to the output region A of the speaker 33a increases, the controller 240 may control the speaker 33a to decrease the output intensity. For example, the controller 240 may control the output intensity of the speaker 33a such that a volume of sounds output from the speaker 33a gradually decreases. However, the variable used to control the output of the speaker 33a is not limited to the volume of sounds and any other variables, such as frequency, may also be controlled.

In FIGS. 7 and 8, upon completion of the control process desired by the user, a control process of converting the user interface device 200 into an inactive state may be performed. This control process is the same as that of converting the user interface device 200 into the active state, and descriptions presented above will not be repeated herein.

The controller 240 may determine a movement direction of the user's gesture based on image information acquired by the acquisition unit 210 and control an output direction of the output device 220 based on information about the movement direction of the gesture.

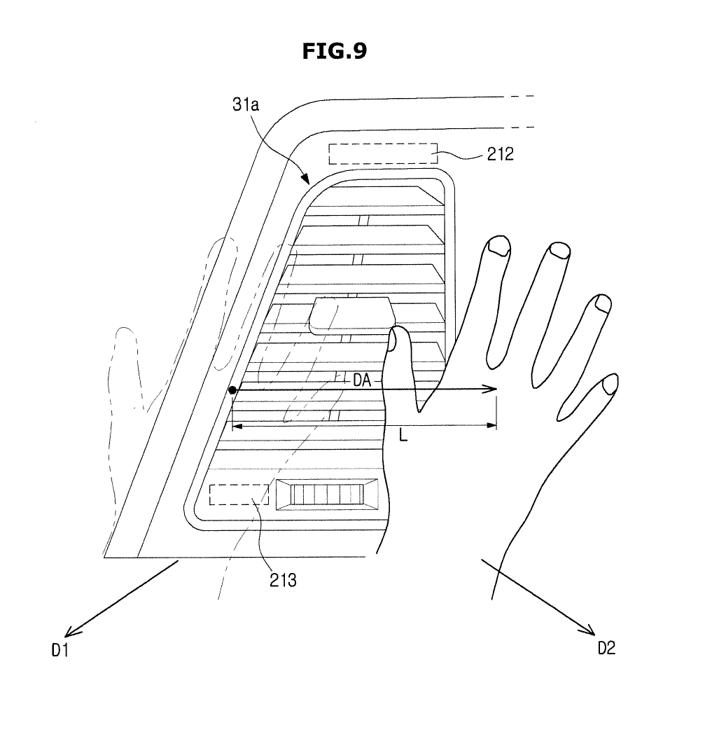

FIG. 9 is a diagram for describing a method of controlling an output direction of the output device 220 in accordance with a movement direction of a gesture. Although FIG. 9 illustrates the air conditioner air vent 31a as the output device 220 as described above with reference to FIGS. 6 and 7, the same principles may also be applied to any other output devices 220 such as the speaker 33a.

Upon receiving an input of a user's gesture moving in a preset first direction DA across the output region A of the output device 220 as illustrated in FIG. 9, the controller 240 may control the output direction of the output device 220 such that the direction of wind is converted into the first direction DA. In this case, the direction of wind output from the output device 220 may be converted from one direction DA to another direction D2. In this regard, the first direction DA may be an upward, downward, leftward, or rightward direction with respect to a direction facing the front of the vehicle 100. According to an embodiment, the first direction DA may be any direction set by the user.

The controller 240 may control a conversion angle of the direction of wind based on a length, i.e., a distance, of the gesture moving in the first direction DA across the output region A. For example, the controller 240 may control the conversion angle of the direction of wind to increase as the distance L of the gesture moving in the first direction DA across the output region A.

Upon receiving an input of a user's gesture moving in another direction different from the preset direction including the first direction DA, the controller 240s may determine that an insignificant gesture is input and maintain the current process of controlling the output device 220.

The method of controlling the output device 220 by the controller 240 when the user's hand is greater than the output region A of the output device 220 has been described above. Next, a method of controlling the output device 220 by the controller 240 when the size of the user's hand is less than that of the output region A of the output device 220 will be described.

Upon determination that the user's hand is smaller than the output region A of the output device 220 based on image information received from the image acquisition unit 211, the controller 240 may determine a ratio of a portion of the user's hand shielding the output region A to the entire area of the user's hand and control the output of the output device 220 based on the determined ratio. According to the embodiment, if the entire hand is included in the output region A of the output device 220, the controller 240 may determine that the entire are of the output region A of the output device 220 is shielded and control the output of the output device 220.

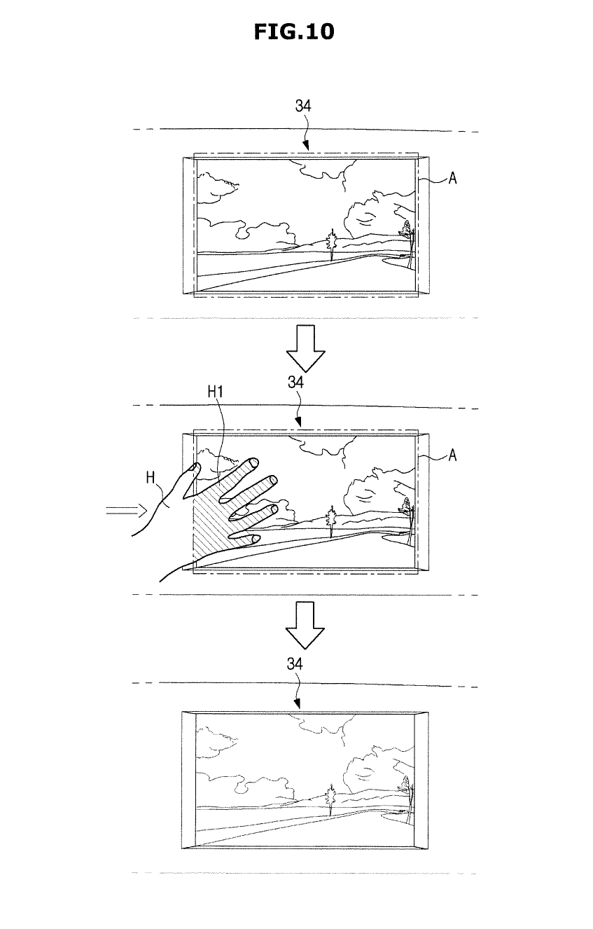

FIG. 10 is a diagram for describing a method of controlling the output of the output device 220 after determining a ratio of a portion of the user's hand shielding the output region A to the entire area of the user's hand. Although FIG. 9 illustrates a display 35 of the AVN device 34 installed in the vehicle 100 as the output device 220, the output device 220 to which the control method according to an embodiment is applied is not limited to the display 35 of the vehicle 100. For example, this method may also be applied to any other output devices 220, which are greater than a gesture input unit such as a user's hand, for example, screens of display apparatuses such as TVs.

Referring to FIG. 10, first, the user may perform a gesture of shielding a portion of the output region A of the display 35 of the AVN device 34. Upon recognition of the user's gesture, the controller 240 may determine a region H1 of the hand shielding the output region A of the display 35 based on image information received from the image acquisition unit 211. Upon determination of the region H1 of the hand shielding the output region A of the display 35, the controller 240 may determine a ratio R2 of the region H1 of the hand shielding the output region A of the display 35 to the entire region H of the hand received from the memory 230 and control the output of the screen of the display 35 based on the determined ratio R2.

For example, as the ratio R2 increases, the controller 240 may control brightness of the screen of the display 35 to increase. On the contrary, the controller 240 may control brightness of the screen of the display 35 to decrease. As the ratio R2 increases, the controller 240 may control the output of the display 35 such that a volume of sounds output from the display 35 increases or decreases.

The controller 240 may also control a size of the screen of the output device 220 based on one point of the gesture. For example, if the output device 220 is the display 35 of the AVN device 34, the controller 240 may control the size of the screen.

The one point of the gesture may be a predetermined point of the hand of the user performing the gesture. For example, the controller 240 may determine a width or length of the screen of the display 35 based on the predetermined point of the user's hand and control the size of the screen of the display 35 while maintaining the original aspect ratio of the screen.

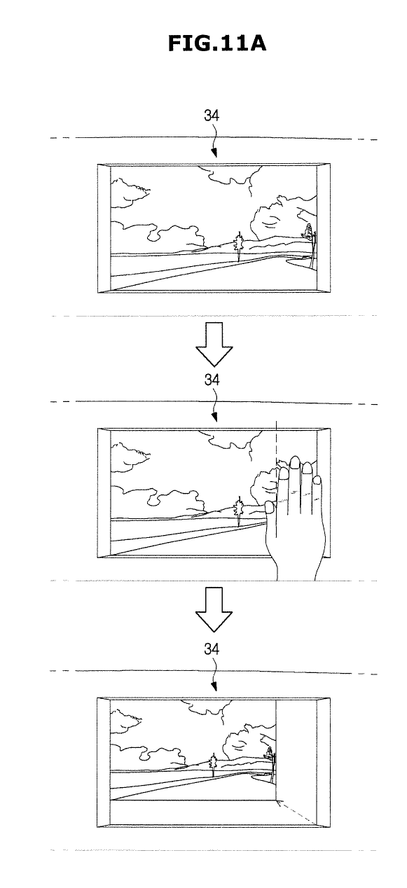

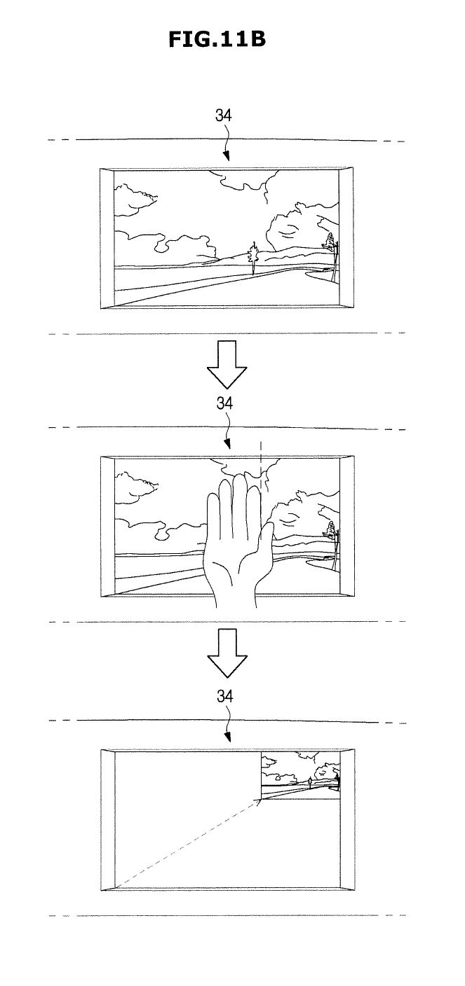

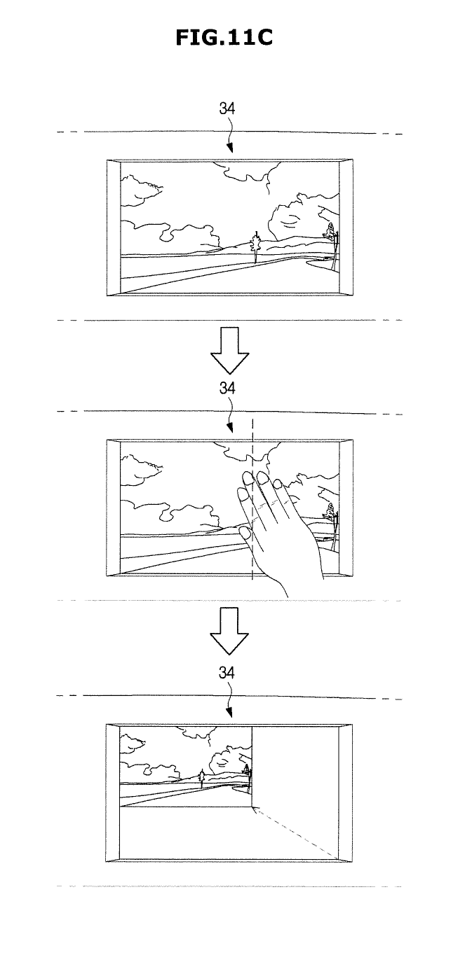

FIGS. 11A to 11C are diagrams for describing methods of controlling a size of a screen of the output device 220 based on one point of a gesture.

Referring to FIGS. 11A and 11B, the controller 240 may recognize an index finger based on information acquired by the acquisition unit 210. Upon recognition of the index finger of the user, the controller 240 may determine a width of the screen based on a virtual line formed by the recognized index finger and control the size of the screen while maintaining the original aspect ratio of the screen based on the determined width.

When the virtual line formed by the index finger of the user is inclined as illustrated in FIG. 11C, the controller 240 may control the size of the screen based on a virtual vertical line formed based on a point where the index finger and a thumb meet.

The user interface device 200 and the vehicle 100 including the same have been described above with various examples of controlling the output of the output device 220 by the controller 240.

Next, the method of controlling the vehicle 100 will be described in more detail.

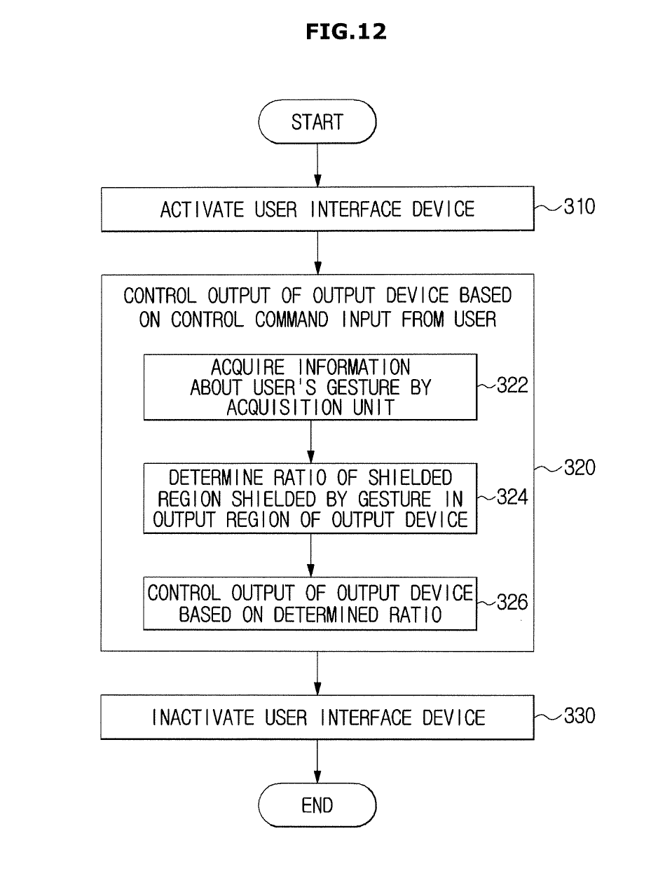

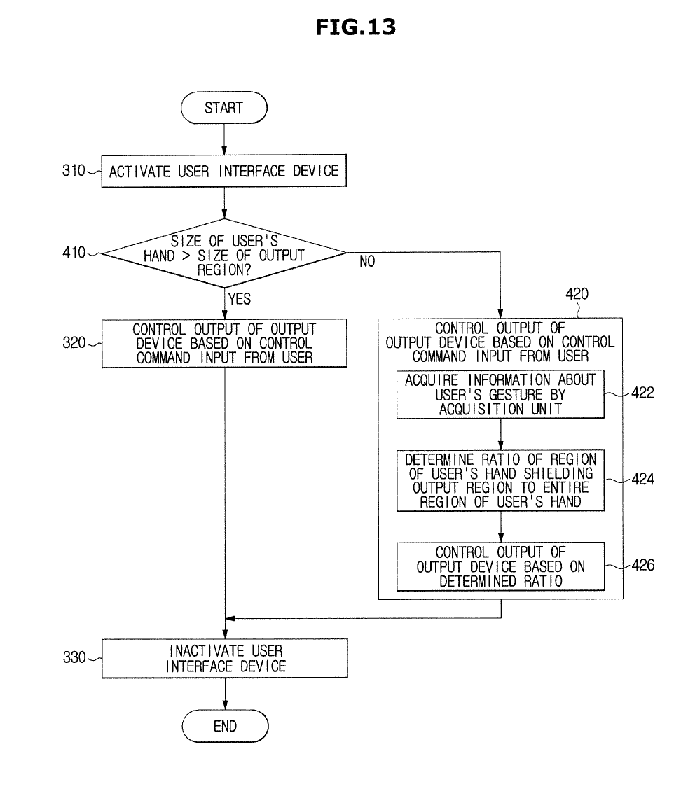

FIG. 12 is a flowchart for describing a process of controlling the vehicle 100 according to an embodiment. FIG. 13 is a flowchart for describing a process of controlling the vehicle 100 according to another embodiment. Hereinafter, the embodiments will be described in detail based on the vehicle 100 having the user interface device 200 described above with reference to FIG. 3.

Referring to FIG. 12, the process of controlling the vehicle 100 includes activating the user interface device 200 (310), controlling the output of the output device 220 in accordance with a control command input from the user (320), and inactivating the user interface device 200 (330).

First, the user interface device 200 may be activated (310). The operation of activating the user interface device 200 may include acquiring information about a user's gesture, and converting the function of the user interface device 200 into an active state if the user's gesture stops in the output region A of the output device 220 for the first period based on the acquired information. In this case, the first period may be set by the user. That is, the user may activate the user interface device 200 by inputting a gesture around the output region A of the output device 220 to be controlled for the preset first period.

When the function of the user interface device 200 to control the output device 220 is activated, the output of the output device 220 may be controlled in accordance with a control command of the user (320).

The controlling of the output of the output device 220 in accordance with the control command input from the user may include acquiring information about a user's gesture by the acquisition unit 210 (322), determining an area of a shielded region shielded by the gesture in the output region A of the output device 220 based on the acquired information (324), and controlling the output of the output device 220 based on the determined area (326).

The controlling of the output of the output device 220 based on the determined area may include determining a ratio of the shielded region shielded by the gesture to the output region A of the output device 220 and controlling the output of the output device 220 based on the determined ratio. For example, if the ratio of the shielded region to the output region A increases, the output intensity of the output device 220 may be controlled to decrease.

The method of controlling the user interface device 200 according to the present embodiment may further include determining a movement direction of the user's gesture based on the information acquired by the acquisition unit 210 and converting an output direction of the output device 220 based on information about the determined movement direction.

Upon completion of the control process, the user interface device 200 may be inactivated (330). This process is similar to that of activating the user interface device 200 described above, and descriptions presented above will not be repeated herein.

Then, referring to FIG. 13, the method of controlling the user interface device 200 may further include determining a size of a user's hand based on information acquired by the acquisition unit 210. In other words, information about the user's hand acquired by the acquisition unit 210 to activate the function of the user interface device 200 may also be used not only to activate the function of the user interface device 200 but also to determine a method of controlling the output device 220 after the user interface device 200 is activated (410).

If the size of the user's hand is greater than that of the output region A of the output device 220, the operation of controlling the user interface device 200 may be performed as illustrated in FIG. 12. In this regard, descriptions presented above (320) will not be repeated herein.

If the size of the user's hand is less than that of the output region A of the output device 220, the output of the output device 220 may be controlled via the following process. First, the acquisition unit 210 acquires gesture information and transmit the acquired gesture information to the controller 240. The controller 240 may determine a ratio of a region H1 of the user's hand shielding the output region A to the entire region H of the user's hand based on the acquired information, and control the output of the output device 220 based on the determined ratio (420). Here, descriptions presented above will not be repeated herein.

Upon completion of the control process, the user interface device 200 may be inactivated (330).

As is apparent from the above description, according to the user interface device, the vehicle including the same, and the method of controlling the vehicle, the user may control various functions provided in the vehicle more intuitively.

Although the user interface device, the vehicle, and the method of controlling the vehicles according to a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A user interface device comprising:
an output device having an output region predefined around an output unit;
an acquisition unit acquiring information about a user's gesture performed around the output region; and
a controller determining an area of a shielded region, which is shielded by the user's gesture in the output region, based on the acquired information and controlling an output of the output device.

2. The user interface device according to claim 1, wherein the user's gesture comprises a gesture of shielding the output region with a user's hand.

3. The user interface device according to claim 1, wherein the output region is defined in the same shape as that of the output device.

4. The user interface device according to claim 1, wherein the controller determines a ratio of the shielded region to the output region and controls the output of the output device based on the determined ratio.

5. The user interface device according to claim 4, wherein the controller controls the output of the output device to decrease when the ratio of the shielded region to the output region increases.

6. The user interface device according to claim 1, wherein the controller determines a movement direction of the user's gesture based on the acquired information about the gesture, and controls an output direction of the output device based on information about the movement direction of the user's gesture.

7. The user interface device according to claim 1, wherein upon determination that a size of the user's hand is less than that of the output region based on the acquired information, the controller determines a ratio of a region of the user's hand which shields the output region to the entire region of the user's hand and controls the output of the output device based on the determined ratio.

8. The user interface device according to claim 1, wherein the output device comprises a display device, and a size of a screen of the display device is controlled based on a predetermined point of the user's hand.

9. The user interface device according to claim 1, wherein the controller controls an operation of activating a function of the user interface device when the user's gesture of shielding the output region stops around the output region for a reference period.

10. The user interface device according to claim 1, wherein the output device comprises at least one of a speaker, an audio, video, and navigation (AVN) device, an air conditioner, and a window as the output device installed in the vehicle.

11. The user interface device according to claim 1, wherein the acquisition unit comprises at least one of an image acquisition unit, a distance sensor, and a proximity sensor to acquire information about the user's gesture.

12. The user interface device according to claim 1, wherein the acquisition unit is installed around the output device to acquire information about the user's gesture performed around the output device.

13. A vehicle comprising:
an output device having an output region predefined around an output unit;
an acquisition unit acquiring information about a user's gesture performed around the output region; and
a controller determining an area of a shielded region shielded by the user's gesture in the output region based on the acquired information and controlling an output of the output device.

14. The vehicle according to claim 13, wherein the user's gesture comprises a gesture of shielding the output region with a user's hand.

15. The vehicle according to claim 13, wherein the output region is defined in the same shape as that of the output device.

16. The vehicle according to claim 13, wherein the controller determines a ratio of a shielded region shielded by the gesture to the output region and controls the output of the output device based on the determined ratio.

17. The vehicle according to claim 16, wherein the controller controls the output of the output device to decrease when the ratio of the shielded region to the output region increases.

18. The vehicle according to claim 13, wherein the controller determines a movement direction of the gesture based on the acquired information about the gesture, and controls an output direction of the output device based on information about the movement direction of the gesture.

19. The vehicle according to claim 13, wherein upon determination that a size of the user's hand is less than that of the output region based on the acquired information, the controller determines a ratio of a region of the hand shielding the output region to the entire region of the hand and controls the output of the output device based on the determined ratio.

20. The vehicle according to claim 13, wherein the output device further comprises a display device, and a size of a screen of the display device is controlled based on a predetermined point of the user's hand.

21. The vehicle according to claim 13, wherein the controller controls an operation of activating a function of the user interface device if the user's gesture shielding the output region stops around the output region for a reference period.

22. A method of controlling a vehicle, which comprises an output device having an output region predefined around an output unit and an acquisition unit acquiring information about a user's gesture performed around the output region, the method comprising:
acquiring the information about the user's gesture;
determining an area of a shielded region which is shielded by the gesture in the output region of the output device based on the acquired information; and
controlling an output of the output device based on information about the determined area.

23. The method according to claim 22, wherein the controlling of the output of the output device based on the information about the determined area comprises determining a ratio of the shielded region shielded by the gesture to the output region and controlling the output of the output device based on the determined ratio.

24. The method according to claim 22, wherein the controlling of the output of the output device based on the information about the determined area comprises controlling an output intensity of the output device to decrease as the ratio of the shielded region to the output region increases.

25. The method according to claim 22, wherein the method further comprises determining a size of the user's hand based on the information acquired by the acquisition unit, and
the controlling of the output of the output device comprises: determining a ratio of a region of the hand shielding the output region to the entire region of the hand if the determined size of the user's hand is less than that of the output region of the output device; and controlling the output of the output device based on the determined ratio.

26. The method according to claim 22, wherein the method further comprises:
determining a period during which the gesture stops around the output region based on the acquired information about the user's gesture; and
converting the operation of activating the function of the user interface device when the user's gesture stops around the output region for a reference period.

27. The method according to claim 22, wherein the method further comprises:
determining a movement direction of the gesture based on the acquired information about the user's gesture; and
converting an output direction of the output device based on information about the movement direction of the gesture.
